(19) United States
(12) Patent Application Publication
(10) Pub. No.: US 2020/0162370 A1
(43) Pub. Date: May 21, 2020

(54) METHOD, APPARATUS AND COMPUTER PROGRAM FOR SERVICE FUCTION CHAINING

(71) Applicant: Atto Research Co., Ltd., Seongnam (KR)

(72) Inventor: Yong Joo SONG, Seongnam (KR)

(21) Appl. No.: 16/676,272

(22) Filed: Nov. 6, 2019

(30) Foreign Application Priority Data
Nov. 21, 2018 (KR) 10-2018-0144465

(51) Int. Cl. H04L 12/725; H04L 12/721; H04L 12/931; G06F 9/455

(52) U.S. Cl. CPC H04L 45/306; H04L 45/38; G06F 2009/45595; G06F 9/45558; H04L 49/70

(57) ABSTRACT

A method for operating a service function chain in a networking function virtualization device includes: a step a of generating at least one service function chain providing at least one virtual network function, and defining traffic to which the service function chain is applied; a step b of setting an NIC to allocate SR-IOV for the start and end of the service function chain applied to first traffic; and a step c of setting a software switch to apply a flow rule for leading the first traffic to provide the intermediate step of the service function chain to the first traffic.

### BACKGROUND OF THE INVENTION

The present application claims priority to Korean Patent Application No. 10-2018-0144465, filed Nov. 21, 2018, the entire contents of which is incorporated herein for all purposes by this reference.

### FIELD OF THE INVENTION

The present invention relates to a method for operating a service function chain (SFC) in a network function virtualization (NFV). More specifically, the present invention relates to a method for providing high speed of a service function chain in both aspects of hardware and software together.

### DESCRIPTION OF THE RELATED ART

Recently, network function virtualization technology causes a new change throughout hardware-oriented network architecture. The network function virtualization, that is, NFV is a concept of separating hardware and software which are constituent elements of network and virtualizes a function of physical network facility to be executed in a virtual machine (VM) server, hardware provided with a general-purpose processor, and a clouding computer.

According to this, since it is possible to implement various kinds of equipment such as a router, a load balancer, a firewall, an intrusion prevention device, and a virtual private network in a general server with software, it is possible to break away from vendor dependency in network configuration. This is because expensive proprietary equipment can be replaced with general purpose hardware and dedicated software. Furthermore, there is an advantage of not only reducing equipment operation costs but also responding to traffic changes quickly.

Meanwhile, software-defined networking, that is, SDN technology has a characteristic of separating a complicated control plane function from a data plane. According to this, the complicated function of the control plane is processed with software, and the data plane performs only a simple function instructed by the control plane such as transmission, ignore, and change of network packets.

When applying such technology, it is possible to develop a new network function with software without constraint of complicated hardware, and it is possible to make various attempts which are impossible in the previous network structure.

The NFV and SDN are separate technologies but can work complementarily. This is because various network functions implemented with software by the NFV can be efficiently controlled using the SDN.

This work was supported by Institute of Information & Communications Technology Planning & Evaluation (IITP), a grant funded by Korea government (Ministry of Science and ICT) (no. 2016-0-00078, Cloud Based Security Intelligence Technology Development for the Customized Security Service Provisioning

### CITATION LIST

### Patent Literature

Non-Patent Literature 1: Open Networking Foundation, “OpenFlow Specification 1.2.0”

### SUMMARY OF THE INVENTION

The invention is to efficiently process packets in a network function virtualization device. Particularly, the invention is to provide a method for efficiently achieving a high speed of a service function chain by combining a software switch and SR-IOV.

A method for operating a service function chain in a networking function virtualization device according to an embodiment of the invention includes: a step a of generating at least one service function chain providing at least one virtual network function, and defining traffic to which the service function chain is applied; a step b of setting an NIC to allocate SR-IOV for the start and end of the service function chain applied to first traffic; and a step c of setting a software switch to apply a flow rule for leading the first traffic to provide the intermediate step of the service function chain to the first traffic.

### BRIEF DESCRIPTION OF THE DRAWINGS

FIG. 1 is a diagram illustrating service function chaining implemented using an NFV device.

FIG. 2 is a diagram illustrating a method for a high speed of service function chaining.

FIGS. 3A and 3B are diagrams illustrating another method for accelerating service function chaining.

FIG. 4A is a diagram illustrating an example providing a performance-critical service function chain in the NFV device according to the embodiment of the invention.

FIG. 4B is a diagram illustrating an example of providing a service function chain where performance is not critical in the NFV device according to the embodiment of the invention.

FIG. 4C is a diagram illustrating an example of processing general traffic to which a service function chain is not provided, in the NFV device according to the embodiment of the invention.

FIG. 5 is a diagram illustrating a specific process of processing packets according to the embodiment of the invention.

### DETAILED DESCRIPTION OF THE PREFERRED EMBODIMENTS

It is apparent that the invention is not limited to the description of the embodiments described below, and various modifications may be made without departing from the technical scope of the invention. In describing the embodiments, descriptions of technical contents which are widely known in the technical field to which the invention belongs and are not directly related to the technical gist of the present invention will be omitted.

Meanwhile, like elements are denoted by like numerals in the accompanying drawings. In the accompanying drawings, some components may be exaggerated, omitted, or schematically illustrated. This is to clarify the gist of the invention by omitting unnecessary description that is not related to the gist of the invention. Hereinafter, exemplary embodiments of the invention will be described in detail with reference to the accompanying drawings.

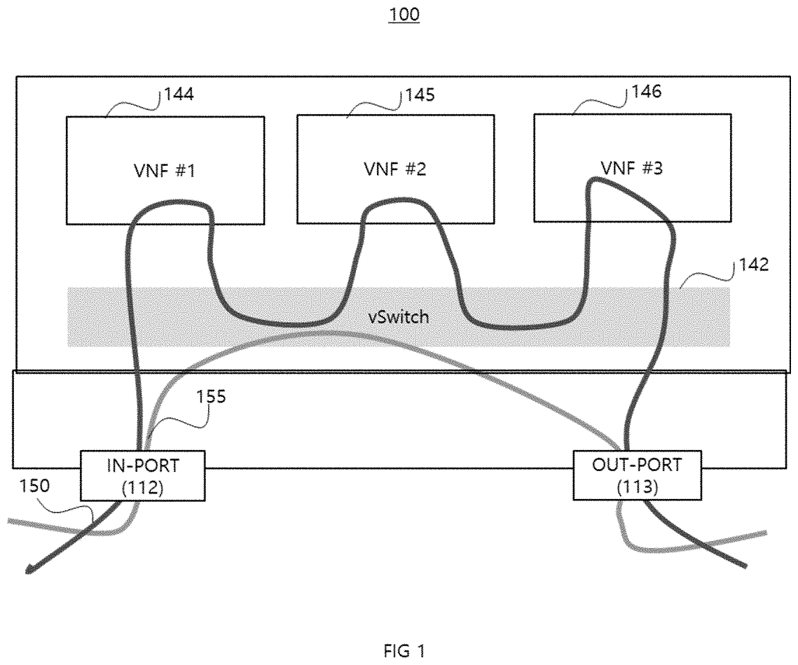

For example, when an NFV device is implemented by one physical server, in the example of FIG. 1, an NFV device 100 may include one or more virtual machines 144, 145, and 146 and a software switch 142 which provide a virtual network function, and ports 112 and 113 which connect a physical network to other servers.

The software switch 142 can play a role of a virtual network hub which connects virtual network equipment driven in an installed server to an external physical network. The virtual machines 144, 145, and 146 can play a role of a function provided by the conventional hardware-based network equipment based such as load balancing, a virtual private network, a firewall, an intrusion prevention function.

In the example of FIG. 1, packets passing through the NFV device are received through an input port 112 which is a physical network interface card (PNIC) of the NFV device, pass through the software switch 142, pass through a service chain which connects at least one of the plurality of virtual machines 144, 145, and 146 providing the VNF, and are forwarded through an output port 113 of the NFV device.

In this case, the software switch 142 plays a role of a virtual network hub which connects virtual network functions driven in an installed server to an external physical network. Accordingly, in order to operate a service chain function, it is general to implement a software switch in one NFV device, and to operate at least one service function chain by setting a flow rule to the software switch.

However, there is a situation that a packet processing speed in an operating system cannot keep up with the speed while the processing speed of network interface equipment (NICs) increases rapidly. In the example of FIG. 1, even when the pack processing speed of NIC is 10 G, the processing speed of the software switch 142 does not reach the speed. Accordingly, a situation that overall system performance decreases may occur.

Meanwhile, in the example of FIG. 1, while the traffic 150 passes through the service function chain, the traffic 155 does not pass through the service function chain and merely passes through the network function virtualization device 100. However, the traffic flowing into the NFV device is processed through the software switch as illustrated in FIG. 1 even when not passing through the service function chain. In other words, even in the case of general traffic to which the service function chain is not provided, the traffic is processed through the software switch. Accordingly, there are problems that unnecessary resources are consumed and setting of the software switch is complicated.

Acceleration technology that can be applied to overcome the performance degradation that occurs during the processing of packets in the NFV device may be considered. For example, acceleration technology may be applied such as a data plane development kit (DPDK) as a software method, and single root I/O virtualization (SR-IOV) as a hardware method.

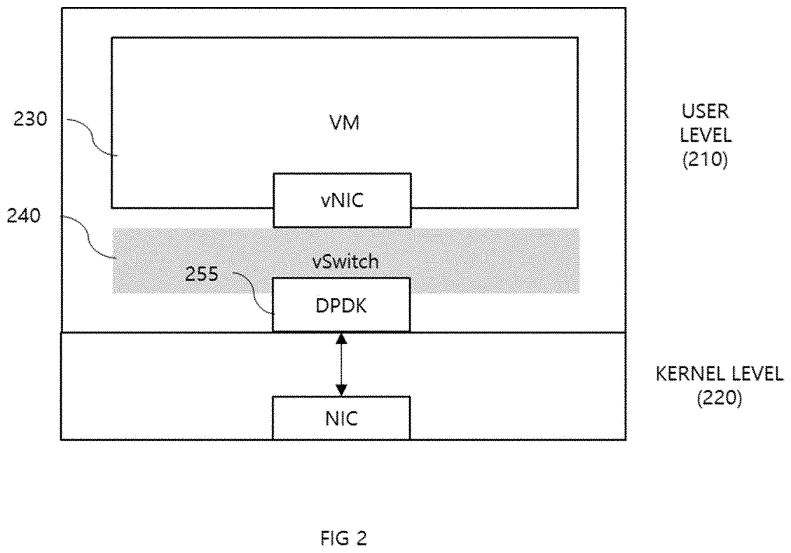

FIG. 2 illustrates an example in which a virtual NIC 245 and a physical NIC 250 of a virtual machine 230 are directly connected through a data plane development kit (DPDK).

The data plane development kit (DPDK) 255 is an acceleration method in which all processes of packets operated in a kernel level of a virtualization infra are performed in a user level. When a kernel level 230 and a user level 210 are separate and a virtualization infra is designed, the kernel level and the user level are repeated to process packets of a virtual machine. This is because interrupt may occur since data movement occurs and computing resources are consumed in such a context switching process.

The DPDK may be called a set of network interface controller drivers and data plane libraries for fast packet processes and can be supported in a software switch 240 made in open flow.

A general network driver is made for Ethernet interface required in an operating system. The DPDK provides an interface through a user level application can directly control hardware without help from the operating system without overhead. Accordingly, packets can be transmitted directly to the virtual machine 230 without having to repeat the user level and the kernel level.

However, even when using DPDK 255, packet processing performance depends on the number of queues of transmitting packets to the virtual machine 230. In other words, if the system supports one queue, limitation occurs in performance. Furthermore, when the processing speed of the virtual machine 230 is not enough, a bottleneck phenomenon of the virtual machine may still occur.

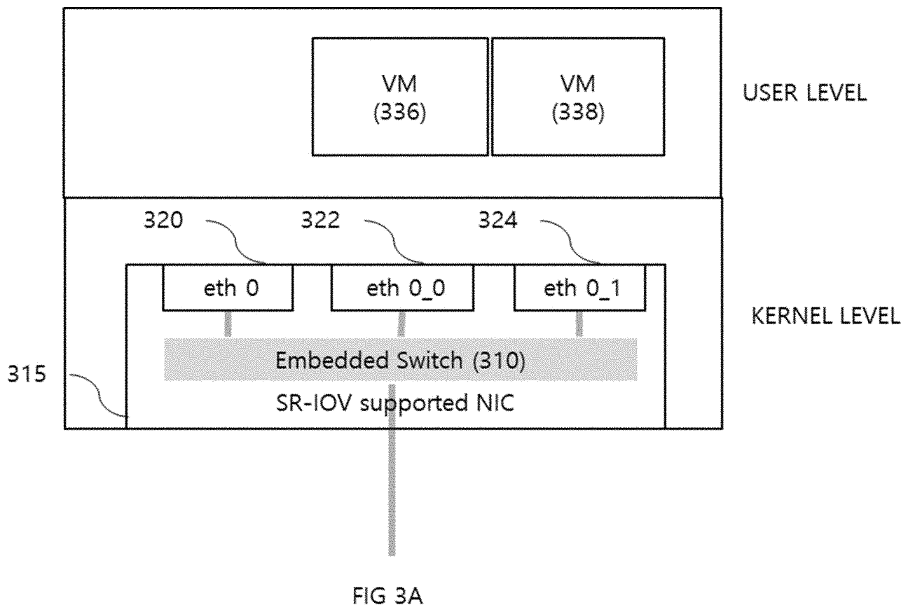

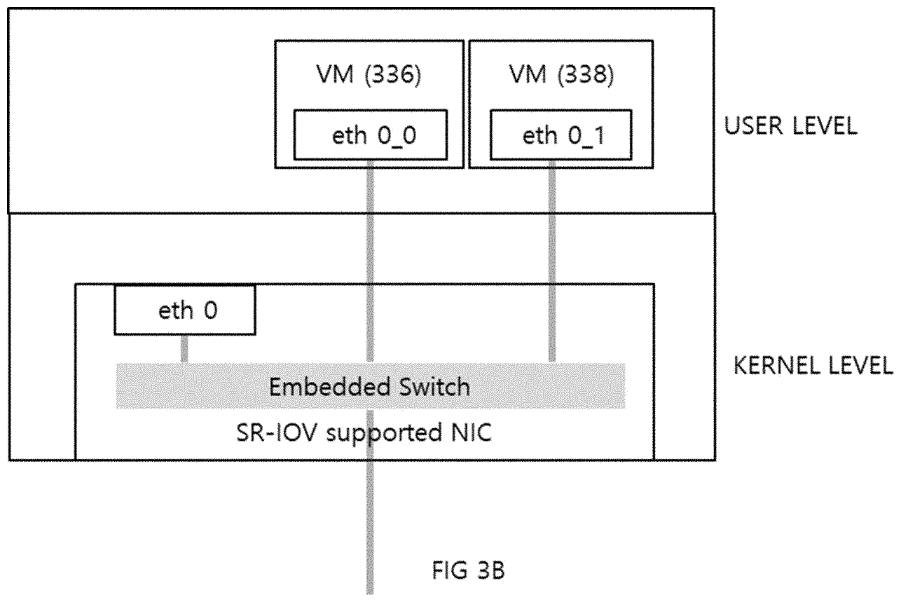

Meanwhile, FIG. 3 is a diagram illustrating acceleration technology using single root I/O virtualization (SR-IOV).

The SR-IOV is technology for a plurality of virtual machines to share one I/O peripheral component interconnect (PCI) express hardware interface. When using SR-IOV, the virtual machine has the same effect as a PCI device connected directly, and it is possible to prevent performance degradation due to virtualization.

Generally, in order to use a host device in a virtual machine, a virtual host driver supporting virtual environment has to be used. However, when applying the SR-IOV, the virtual machine can take advantage of using device drivers and directly accessing the NIC.

In the example of FIG. 3A, reference numeral 315 denotes a physical function (PF) and means a physical PCI card, and reference numerals 320, 322, and 324 denote a virtual function (VF) and can be understood as a virtual NIC, that is, a virtual PCI card. The traffic flowing into the NFV device is distributed to the virtual NIC 320, 322, and 324 through the switch function 310 provided in the NIC and is processed in device drivers of the virtual machines 336 and 338. The virtual machines 336 and 338 may obtain a result of bypassing an OS of a host like being directly connected to the PCI device as illustrated in FIG. 3B.

However, since the SR-IOV is a hardware method, the number of queues and the number of VFs transmitting packets for each NIC are limited. Accordingly, when the VF is allocated to each virtual machine, there is a limit to support only the maximum 32 to 64 virtual machines. Furthermore, the SR-IOV uses a process of the NIC, and depends on a PCI express bus of the physical NIC. Accordingly, there may a problem that it may be operated very fast in one chain, but the speed is rapidly decreased when the number of service function chains is increased.

The invention has been made to solve the problems described above.

According to the embodiments of the invention, it is possible to accelerate a service function chain by mixing a software switch and SR-IOV.

For example, the SR-IOV function is applied to the start and end of a performance-critical service function chain, and the intermediate step of the service function chain may be set to process packets in the software switch. Furthermore, when performance of the service function chain is not critical, it is possible to make setting to process packets in the software switch without applying the SR-IOV. In the case of traffic, which does not need to apply the service function chain, of the traffic flowing into the network function virtualization device, it is possible to make setting to directly forward the traffic to the other device without using a software switch function by applying the SR-IOV.

According the embodiment, it is possible to provide a high speed of a plurality of service function chains since the minimal VFs are used, while a high speed of the service function chains is secured by solving a bottleneck phenomenon of the VM path in the NIC. Furthermore, traffic, which is not provided to the service function chain, of the traffic flowing into the network function virtualization device is forwarded directly to the outside of the device by applying the SR-IOV, thereby reducing the setting of the software switch.

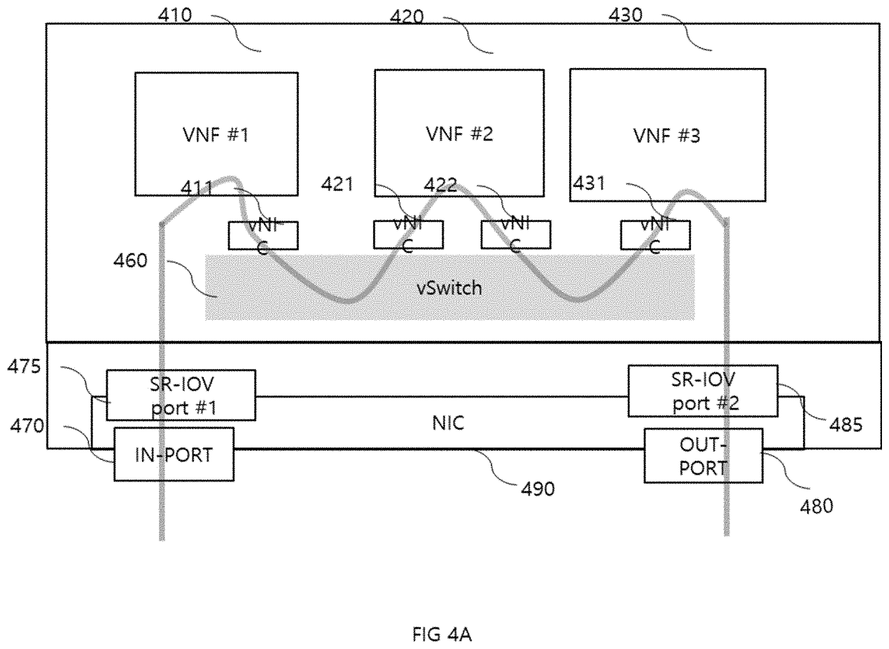

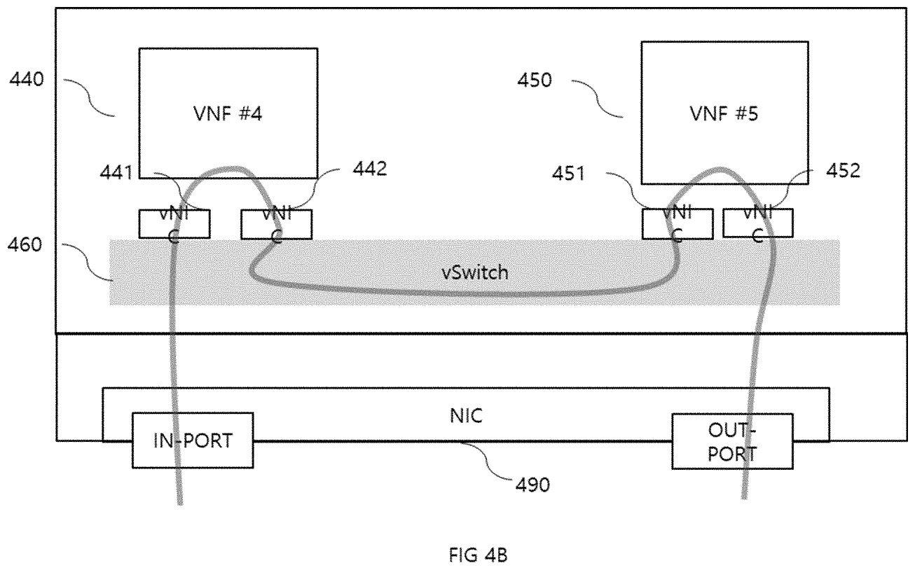

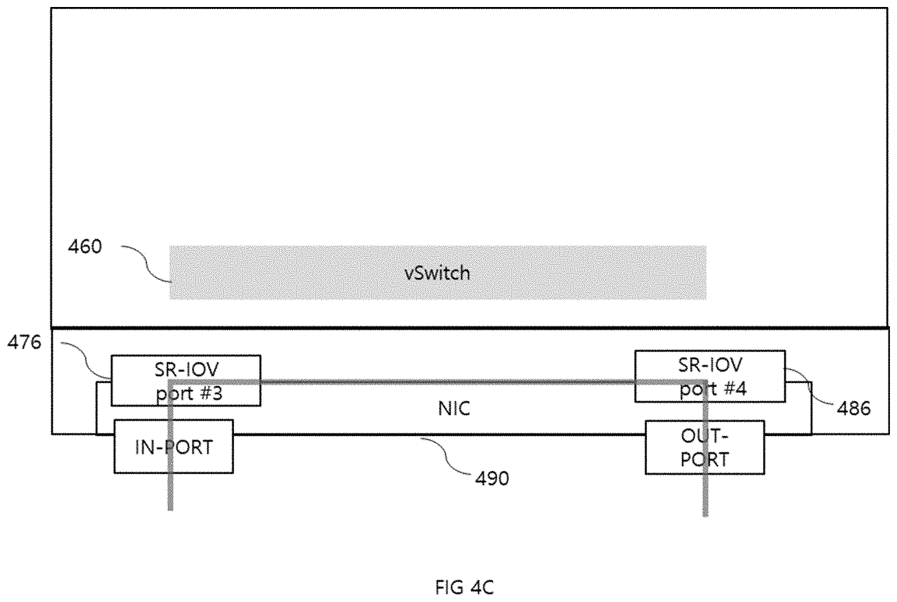

FIG. 4 is a diagram illustrating an example of processing traffic in the network function virtualization device according to the embodiment of the invention.

The NFV device according to the embodiment of the invention can classify traffic flowing into the NFV device, into first traffic to which a performance-critical service function chain is provided, second traffic to which a service function chain where performance is not critical is not critical, and third traffic to which a service function chain is not provided. This is classification of traffic in accordance with performance of a required service function chain, to provide a high speed of a plurality of service function chains while using the minimal SR-IOV.

FIG. 4A is a diagram illustrating an example providing a performance-critical service function chain in the NFV device according to the embodiment of the invention.

For example, as illustrated in FIG. 4A, it may be assumed that performance of a first service function chain providing a network function in order of first NFV, second NFV, and third NFV is critical. According to the embodiment of the invention, the SR-IOV function is applied to the start and end of a performance-critical service function chain, and the intermediate step of the service function chain may be set to process packets in the software switch.

More specifically, according to the embodiment of the invention, when traffic providing the first service function chain flows in through an in-port 470, the traffic is distributed to an SR-IOV port 475 allocated in advance to a first service function chain through a switch function provided in an NIC 490. In this case, the traffic bypasses a kernel level and is provided in a device driver of a first virtual machine 410, and a first VNF is provided.

Thereafter, the first virtual machine 410 forwards the traffic from a software switch 460 to a virtual port 411 generated for the first virtual machine, and the software switch 460 forwards the traffic to a virtual port 421 generated for a second virtual machine in accordance with a preset flow rule.

Thereafter, a second virtual machine 420 forwards the traffic from the software switch 460 to a virtual port 422 generated for the second virtual machine, and the software switch 460 forwards the traffic to a virtual port 431 generated for a third virtual machine in accordance with a preset flow rule.

Thereafter, the third virtual machine 430 bypasses the kernel level and transmits the traffic to the NIC, the traffic is distributed to an SR-IOV port 485 allocated in advance to the first service function chain through the switch function provided in the NIC 490, and the traffic is forwarded from the NFV device to the other device.

According to such an embodiment illustrated in FIG. 4A, the SR-IOV function is applied to the start and end of the service function chain to secure a high speed of the service function chain, while the traffic is led through the software switch in the intermediate step of the service function chain. Accordingly, there is an effect of using the minimal VFs.

FIG. 4B is a diagram illustrating an example of providing a service function chain where performance is not critical in the NFV device according to the embodiment of the invention.

For example, as illustrated in FIG. 4B, it may be assumed that performance of a second service function chain providing a network function in order of fourth NFV and fifth NFV is not critical. According to the embodiment, it is possible to lead the traffic through the software switch as conventional, without apply the SR-IOV function to the service function chain where performance is not critical.

More specifically, according to the embodiment of the invention, when traffic providing the second service function chain flows in through the in-port 470, the traffic is processed in the software switch 460 and the second service function chain is provided.

In other words, the traffic is forwarded from the software switch 460 to a virtual port 441 generated for a fourth virtual machine 440, the fourth virtual machine provides a fourth NFV to the traffic, then the fourth virtual machine 440 forwards the traffic from the software switch 460 to a virtual port 442 generated for the fourth virtual machine, and the software switch 460 forwards the traffic to a virtual port 451 generated for a fifth virtual machine in accordance with a preset flow rule.

Thereafter, the fifth virtual machine 450 forwards the traffic from the software switch 460 to a virtual port 452 generated for the fifth virtual machine, the software switch 460 forwards the traffic through an out-port in accordance with a preset flow rule, and the traffic is forwarded from the NFV device to the other device.

FIG. 4C is a diagram illustrating an example of processing general traffic to which a service function chain is not provided, in the NFV device according to the embodiment of the invention.

For example, as illustrated in FIG. 4C, in the case of traffic, which does not need to apply a service function chain, traffic flowing into a network function virtualization device, it is possible make setting to directly forward the traffic to the other device without using a software switch function by apply the SR-IOV.

More specifically, when the traffic, which does not need to apply a service function chain, flows in through the in-port 470, the traffic is distributed to an SR-IOV port 476 allocated in advance to such traffic through a switch function provided in the NIC 490, and is forwarded from the NFV device to the other device through a connected SR-IOV port 486 without passing through the software switch 460.

According to such an example illustrated in FIG. 4C, traffic, which is not provided to a service function chain, of the traffic flowing into the network function virtualization device is directly forwarded to the outside of the device by applying the SR-IOV, thereby reducing the setting of the software switch.

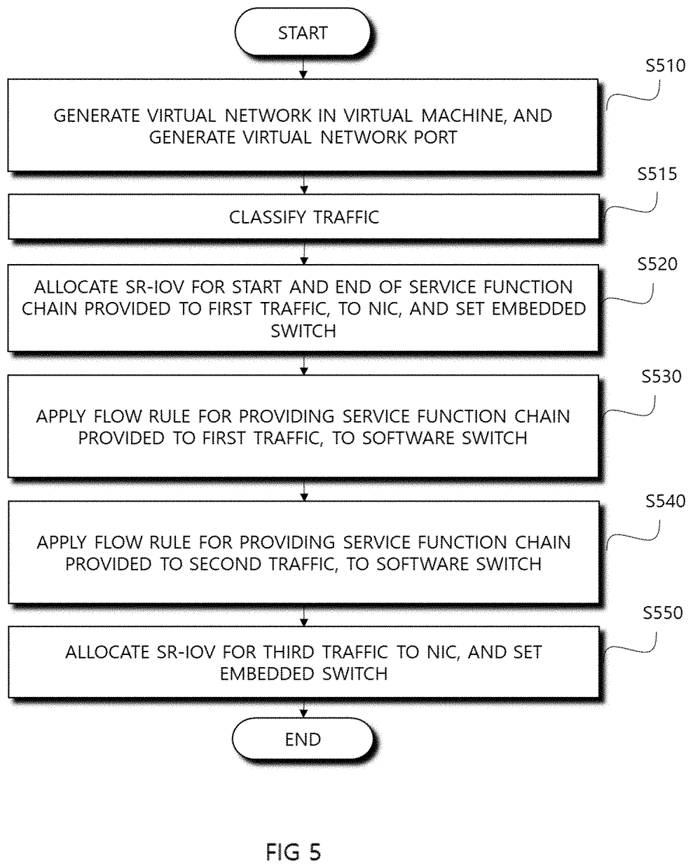

FIG. 5 is a diagram illustrating a specific process of processing packets in the network function virtualization device according to the embodiment of the invention.

The network function virtualization device according to the embodiment of the invention may generate a virtual machine, a software switch, and a virtual network function in Step 510. Furthermore, the software switch may generate a virtual port of the virtual machine to be connected the virtual machine. In addition, at least one virtual network function may be connected to generate at least one service function chain, and traffic providing a service function chain may be defined.

In Step 515, the network virtualization device may classify traffic flowing in. For example, in the service function chains generated in Step 510, traffic to which a performance-critical service function chain is provided may be classified into first traffic, traffic to which a service function chain where performance is not critical is provided may be classified into second traffic, and traffic to which a service function chain is not provided may be classified into third traffic. This is to optimize the user of the SR-IOV of the NIC of the network function virtualization device, and to allocate the SR-IOV in accordance with the classification when traffic flows into the NIC.

In Step 520, the network function virtualization device allocates the SR-IOV for the first traffic, that is, the traffic to which a performance-critical service function chain is provided and can set the NIC built-in switch to distribute the traffic to the SR-IOV. This is for the start and end of the service function chain provided to the first traffic.

In Step 530, the network function virtualization device can set a flow rule for leading the first traffic to the software switch. This is for the intermediate step of the service function chain provided to the first traffic.

According to this, when the first traffic flows in through the in-port, the first traffic is distributed to the SR-IOV allocated in advance through the switch function provided in the NIC. Thereafter, the first traffic bypasses a kernel level, and flows into the first virtual machine providing the service function chain, thereby providing the virtual network function. Thereafter, the other virtual network function is provided through the software switch, the first traffic bypasses the kernel level in the last virtual machine providing the service function chain, is distributed the SR-IOV port allocated in advance and is forwarded to the other device in the NFV device.

Accordingly, the service function chain is quickly processed by applying the SR-IOV function to the start and end of the service function chain, while the traffic is led through the software switch in the intermediate step of the service function chain. Accordingly, there is an effect of providing a high speed of the service function chain only with the minimal SR-IOV.

Meanwhile, in Step 540, the network virtualization device may set a flow rule for leading the second traffic to the software switch, that is, the traffic to which the service function chain where performance is not critical is provided. This is to provide the service function chain by using the software switch as conventional to save SR-IOV resources since the service function chain provided to the second traffic does not need to be particularly quickly processed.

According to this, when the second traffic flows in through the in-port, the software switch leads the second traffic in accordance with the flow rule and provides the service function chain.

Furthermore, in Step 550, the network function virtualization device can allocate the SR-IOV for the third traffic, that is, the general traffic which does not need to provide the service function chain, to the NIC.

More specifically, when the third traffic flows in, the network function virtualization device distributes the traffic to the allocated SR-IOV, and the NIC built-in switch may be set to forward the traffic through the other connected SR-IOV port. This is to forward the traffic to the other device directly without using the software switch function by applying the SR-IOV in the case of the traffic which does not need to apply the service function chain.

The embodiments of the invention disclosed in the specification and the drawings are only specific examples to easily explain the technical contents of the invention and aid the understanding of the invention and are not intended to limit the scope of the invention. It is apparent to those skilled in the art that other modifications based on the technical idea of the invention can be carried out in addition to the embodiments disclosed herein.

According to the invention, since it is possible to process traffic flowing into the network function virtualization device by combining the software switch and the SR-IOV, it is possible to provide a high-speed service function chain and efficient traffic forwarding.

While the present invention has been described with respect to the specific embodiments, it will be apparent to those skilled in the art that various changes and modifications may be made without departing from the spirit and scope of the invention as defined in the following claims.

What is claimed is:

1. A method for operating a service function chain in a networking function virtualization device, comprising:
a step a of generating at least one service function chain providing at least one virtual network function, and defining traffic to which the service function chain is applied;
a step b of setting an NIC to allocate SR-IOV for the start and end of the service function chain applied to first traffic;
a step c of setting a software switch to apply a flow rule for leading the first traffic to provide the intermediate step of the service function chain to the first traffic; and
a step in which, when the first traffic flows in, the first traffic flows to a virtual machine providing a first virtual network function of starting the service function chain through an SR-IOV port allocated to the service function chain, is forwarded to a virtual machine providing a second virtual network function provided after the first virtual network function in the service function chain through the software switch, and is carried out from a virtual machine providing a third virtual network function of ending the service function chain through the SR-IOV port allocated to the service function chain.

2. The method for operating a service function chain according to claim 1, wherein the step b includes:
a step of, when the first traffic flows in through the in-port, setting a switch provided in the NIC to be distributed to the SR-IOV allocated to the service function chain; and
a step of, when the first traffic flows in from a virtual machine connected to the SR-IOV port, providing the corresponding virtual network function and setting the virtual machine to forward the first traffic from the software switch to a virtual port generated for the virtual machine.

3. The method for operating a service function chain according to claim 2, further comprising, after the step c, a step of allocating SR-IOV for inflow and SR-IOV for carrying out to second traffic to which there is no need to provide the service function chain, and connecting the SR-IOV for inflow and the SR-IOV for carrying out.
